(19) United States
(12) Patent Application Publication
(10) Pub. No.: US 2020/0073595 A1
(43) Pub. Date: Mar. 5, 2020

(54) Flash memory controller capable of improving IOPS performance and corresponding method

(71) Applicant: Silicon Motion Inc., Hsinchu County (TW)

(72) Inventors: Hsu-Ping Ou, Hsinchu County (TW); Wei-Yi Hsiao, Hsinchu County (TW)

(21) Appl. No.: 16/120,285

(22) Filed: Sep. 2, 2018

(51) Int. Cl. G06F 3/06

(52) U.S. Cl. CPC G06F 3/0679; G06F 3/0655; G06F 3/0611

(57) ABSTRACT

A method of a flash memory controller connected to a flash memory includes: receiving a data unit from the host via a bust of the host; controlling the flash memory to load a full page data from the flash memory into a buffer of the flash memory; and writing the data unit into the buffer to update or replace a portion data of the full page data stored in the buffer, to control the flash memory write the full page data which has been updated by the data unit from the buffer into the flash memory.

### BACKGROUND OF THE INVENTION

### 1. Field of the Invention

The invention relates to a flash memory data programming/writing mechanism, and more particularly to a flash memory controller and a corresponding method.

### 2. Description of the Prior Art

Generally speaking, a conventional flash memory controller is arranged to program or write a full page data amount into a flash memory each time when the conventional flash memory controller issues a program/write command to the flash memory. If data amount transmitted from a host device is smaller than that of one full page data, the conventional flash memory controller is arranged to fill with dummy data after the data amount to form one full page data. Usually, the data amount of filled dummy data is much larger than the data amount transmitted from the host device. The performance of the conventional scheme is inevitably limited due to the transmission time of filled dummy data.

### SUMMARY OF THE INVENTION

Therefore one of the objectives of the invention is to provide a flash memory controller and a corresponding method to solve the problems mentioned above.

According to embodiments of the invention, a flash memory controller is disclosed. The flash memory controller comprises a first I/O interface, a second I/O interface, and a processing circuit. The first I/O interface is configured to be connected to a bus of a host to receive a data unit from the host. The second I/O interface is configured to be connected to a flash memory. The processing circuit is coupled between the first I/O interface and the second I/O interface, and is configured to control the flash memory to load a full page data from the flash memory into a buffer of the flash memory, and to write the data unit into the buffer via the second I/O interface to update or replace a portion data of the full page data stored in the buffer wherein the full page data updated by the data unit is then written into the flash memory.

According to the embodiments, a method of a flash memory controller connected to a flash memory is disclosed. The method comprises: receiving a data unit from the host via a bust of the host; controlling the flash memory to load a full page data from the flash memory into a buffer of the flash memory; and writing the data unit into the buffer to update or replace a portion data of the full page data stored in the buffer, to control the flash memory write the full page data which has been updated by the data unit from the buffer into the flash memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a flash memory controller according to embodiments of the invention.

FIG. 2 is a diagram showing a flowchart of the operation of flash memory controller according to the embodiments of FIG. 1.

FIG. 3 is a time sequence diagram showing an example of flash memory controller sequentially receiving data units and issuing different commands to write the data units into the flash memory for data writing of different data units according to the embodiments of FIG. 1.

### DETAILED DESCRIPTION

To meet the specification of a flash memory, a conventional flash controller may be arranged to program or write a full page data amount into the flash memory each time when the conventional flash memory controller issues a program/write command to the flash memory. If data amount transmitted from a host device is smaller than that of one full page data, the conventional flash memory controller is arranged to fill with dummy data after the data amount to form one full page data. Usually, the data amount of filled dummy data is much larger than the data amount transmitted from the host device. The performance of the conventional scheme is inevitably limited due to the transmission time of filled dummy data.

The invention aims at providing a solution capable of improving IOPS (Input/Output Operations per Second) performance of a flash memory controller without implementing a command queue function by reducing the data amount of dummy data to be transmitted (i.e. equivalently reducing the transmission time of dummy data).

A host device such as a portable electronic device may sequentially send or output a sequence of multiple data units having smaller data sizes to the flash memory controller rather than directly outputting one full page data. For example, if one full page data has 16 KB (kilobyte), the host device may sequentially transmit four data units each having 4 KB; the host device may transmit two data units each having 8 KB or eight data units each having 2 KB. The data amount transmitted from the host device each time is not meant to be a limitation. The host device is arranged to sequentially send a plurality of data units each having the size smaller than one full page data.

In the embodiments, the flash memory controller without implementing a command queue function is arranged to write or program data unit(s) or portion data(s) received from a host device into a flash memory as soon as possible so as to avoid data lost. For example, the input data unit(s) may be processed by the flash memory controller without implementing a command queue function in a first-in-first-out (FIFO) order. However, this is not intended to be a limitation. The input data unit(s) or portion data(s) can be processed by the flash memory controller in other processing orders.

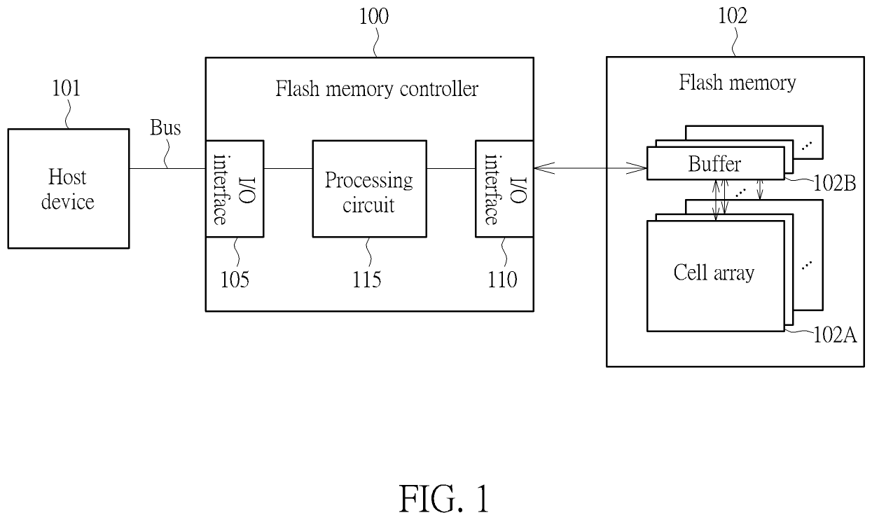

FIG. 1 is a block diagram of a flash memory controller 100 according to embodiments of the invention. The flash memory controller 100 is configured to be connected between a host device 101 and a flash memory 102 such as an NAND flash type memory (but not limited). The flash memory controller 100 and flash memory 102 may be included within a portable electronic device such as a thumb drive, a pen drive, a stick or a disk.

The flash memory controller 100 comprises a first I/O interface 105, a second I/O interface 110, and a processing circuit 115. The flash memory 102 comprises at least one cell array 102A and at least one corresponding buffer 102B. For instance, if the flash memory 102 is a two-plane type flash memory, the flash memory 102 comprises two cell arrays 102A and two buffers 102B.

The first I/O interface 105 is configured to be connected to a port of the host device 101 via the bus such as USB (Universal Serial Bus; but not limited) to receive data units from the host device 101. The second I/O interface 110 is configured to be connected to the flash memory 102 via an internal bus. The processing circuit 115 is coupled between the first I/O interface 105 and the second I/O interface 110, and is configured to program/write data unit(s) from the host device 101 into the flash memory 102. The processing circuit 115 may have an ECC encoding/decoding circuit, a microcontroller, buffer(s), cache(s), register(s), encryption/decryption engine, and/or a control finite stage machine. The functions and operations of above-mentioned circuits are not detailed for brevity.

In the embodiments, to avoid the complexity of the whole system/driver/application designs, the flash memory controller 100 is configured to not support the command queue function for flash memory data programming/writing so as to save costs. Since no command queue functions are implemented to guarantee successful data programming/writing for all data (some data unit(s) may be lost due to that the connection between the host device 101 and flash memory controller 100 is disconnected), the flash memory controller 100 is arranged to write a data unit via the I/O interface 110 into the flash memory 102 each time when receiving such data unit from the host device 101 via the I/O interface 105 to avoid data lost. In addition, when receiving one/each data unit and a corresponding logical address from the host device 101, the processing circuit may be arranged to map the corresponding logical address into a physical address of the flash memory 102 (logical-to-physical mapping).

A size of data unit transmitted and outputted from the host device 101 to the flash memory controller 100 may be different from that of one page data defined in the flash memory 102. In the embodiments, a data unit transmitted and outputted from the host device 101 can be regarded as a management data unit, and the size of the data unit may be different and dependent upon different applications such as video, audio, or other application of the host device 101. In one embodiment, the size of management data unit may be designed as 4 KB (but not limited). Further, one page data means a unit of data programming/writing for the flash memory 102. For example, one page data may be 16 KB for one-plane type flash memory or may be 32 KB for two-plane type flash memory. That is, in the embodiment, the host device 101 may sequentially send or transmit a sequence of multiple 4 KB data into the flash memory controller 100 via the USB bus. For example, the host device 101 may be a portable device capable of capturing high quality images/videos and sequentially transmit and write the captured data into the flash memory to avoid failure of data bust lost. This is not intended to be a limitation. The host device 101 in other embodiments can be used as different devices or purposes.

It should be noted that the size of one management data unit is not limited to 4 KB. In other embodiments, the size can be designed as 1 KB, 2 KB, or dependent upon the system design.

Further, for example, if the size of one management data unit is 4 KB and the size of one page data unit is 16 KB, then four 4 KB data can be arranged to form one page data. That is, a management data unit transmitted and outputted from the host device 101 can be regarded as a portion data of the page data stored in one page data unit of the flash memory 102.

To solve the problem of the conventional scheme, in the embodiments, the flash memory controller 100 is arranged to determine whether a data unit received from the host device 101 is used to form a first portion data of one page data defined in the flash memory 102 wherein the first portion data of one page data means a starting portion data at a starting logical position of the page data. If such data unit is used to form the first portion data, the processing circuit 115 of flash memory controller 100 is arranged to issue the program/write command 80h to program or write data amount of one page data such as 16 KB or 32 KB (i.e. the data unit plus dummy data) into the flash memory 102.

If such data unit is not used to form the first portion data, the processing circuit 115 is arranged to issue a copy back read command to the flash memory 102, to read the data amount of one page data from the cell array 101A to the buffer 102B wherein the read page data may be page data previously stored in a page of the cell array 102A. For example, such data unit may be used to form a second portion data of the page data wherein the logical position of the first portion data is followed by that of the second portion data. In this situation, the copy back read command, issued by the flash memory controller 100, is arranged to read the data unit used for forming the first portion data and other dummy data from the cell array 102A into the buffer 102B. The processing circuit 115 is then arranged to issue a program/write command 80h to write the data unit which is used for forming the second portion data into the flash memory 102 to update a corresponding position of the data amount of one page data which has been read back from the cell array 102A and buffered in the buffer 102B. In this situation, for instance, the data unit which is used for forming the second portion data is arranged to update a position of the second portion data of the page data which has been read back from the cell array 102A. The updated page data amount buffered in the buffer 102B is then written into a page of the cell array 102A. It should be noted that the program/write command 80h is followed by transmission of a single data unit (e.g. 4 KB) rather than one page data amount.

Similarly, if determining that such data unit is used to form a third portion data of the page data, the processing circuit 115 is also arranged to issue the copy back read command to the flash memory 102, to read the data amount of one page data from the cell array 101A to the buffer 102B. In this situation, the data amount of one page data, read back from the cell array 102A, may sequentially comprise the first portion data, the second portion data, and other subsequent dummy data. Then, the processing circuit 115 is also arranged to issue the program/write command 80h to write the data unit used for forming the third portion data into the flash memory 102 to update a corresponding position of the data amount of one page data which has been read back from the cell array 102A and buffered in the buffer 102B. For instance, the data unit which is used for forming the third portion data is arranged to update a position of the third portion data of the page data which has been read back from the cell array 102A. Also, the updated page data amount buffered in the buffer 102B is then written into a page of the cell array 102A. The program/write command 80h is followed by transmission of a single data unit (4 KB) rather than one page data amount.

For each data unit which is used for forming other portion data of one page data rather than the first portion data, the process for issuing the copy back read command and subsequent program/write command is performed similarly to write the data unit into the flash memory 102. In addition, it should be noted that the mentioned page means a logical storage page rather than a physical storage page, and the arrangement/positions of data units in the page means a logical storage arrangement/location rather than a physical storage location. In addition, the flash memory controller 100 is able to support a random write function to randomly program/write multiple consecutive data units in different physical storage pages or different physical positions (still in the same logical storage page).

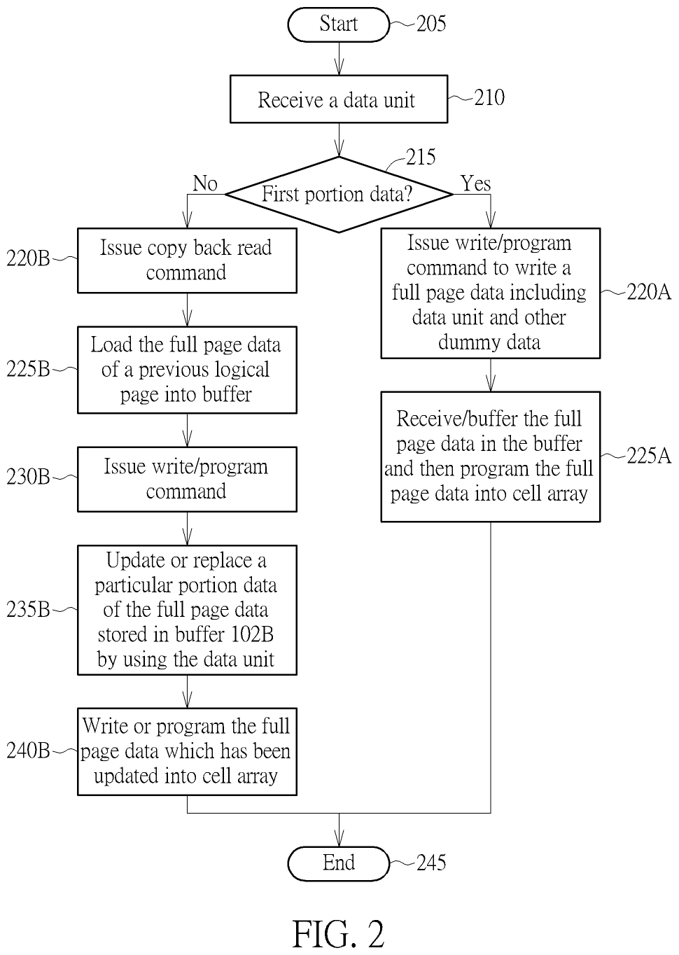

FIG. 2 is a diagram showing a flowchart of the operation of flash memory controller 100 according to the embodiments of FIG. 1. Provided that substantially the same result is achieved, the steps of the flowchart shown in FIG. 2 need not be in the exact order shown and need not be contiguous, that is, other steps can be intermediate. Steps are detailed in the following:

Step 205: Start;

Step 210: Receive a data unit from the host device 101;

Step 215: Determine whether the received data unit is used as a first portion data of one page data; if the received data unit is used as the first portion data, the flow proceeds to Step 220A, otherwise, the flow proceeds to Step 220B;

Step 220A: The processing circuit 110 issues the write/program command 80h to the flash memory 102, to write a full page data including such data unit and other subsequent dummy data;

Step 220B: The processing circuit 110 issues the copy back read command to the flash memory 102;

Step 225A: The flash memory 102 receives and buffers the full page data in the buffer 102B and then writes the full page data into a page of the cell array 102A;

Step 225B: The flash memory 102 loads the full page data of a previous logical page into the buffer 102B when receiving the copy back read command from the controller 100;

Step 230B: The processing circuit 110 issues the write/program command 80h to the flash memory 102, to write a data unit so as to update a particular portion data of the full page data stored in the buffer 102B;

Step 235B: The flash memory 102 is arranged to update or replace the particular portion data of the full page data stored in the buffer 102B by using the data unit following the write/program command 80h when receiving the write/program command 80h for data update;

Step 240B: The flash memory 102 is arranged to write or program the full page data which has been updated into a corresponding page of the cell array 102A; and

Step 245: End.

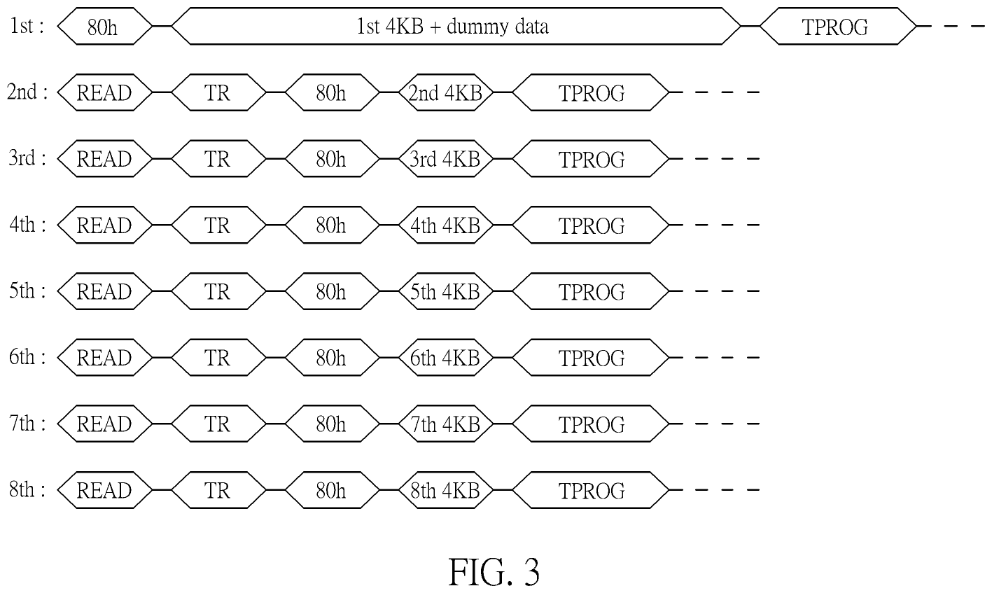

FIG. 3 is a time sequence diagram showing an example of flash memory controller 100 sequentially receiving data units and issuing different commands to write the data units into the flash memory 102 for data programming/writing of different data units according to the embodiments of FIG. 1. For example, the flash memory 102 may be a two-plane type flash memory. One page data may have 32 KB which may be formed by eight data units wherein each data unit has 4 KB. The host device 101 may be arranged to write/transmit 4 KB data to the flash memory controller 100 each time. Alternatively, in other embodiments, the host device 101 may write/transmit different data amount smaller than 4 KB data to the flash memory controller 100 each time, and the flash memory controller 100 is arranged to activate the following operations each time when collecting 4 KB data.

For data programming/writing at the first time, when the flash memory controller 100 receives the first data unit (i.e. the first 4 KB data) and a specific logical address from the host device 101, the processing circuit 115 is arranged to map the specific logical address into a specific physical address and issue/send the program/write command 80h carrying the specific physical address to the flash memory 102 to write 32 KB, i.e. one page data formed by the first 4 KB data and subsequent 28 KB dummy data, into the flash memory 102. The transmission time of the program/write command 80h is followed by the transmission time of 32 KB which is followed by the page program time TPROG. The flash memory 102 is arranged to buffer the 32 KB in the buffer 102B and then write the 32 KB into a page of the cell array 102A during the page program time TPROG. The transmission time of 32 KB is much longer than the page program time TPROG. In this embodiment, the processing circuit 115 is arranged to determine a corresponding data unit as the N-th data portion of one page data based on reception of the specific logical address for the N-th time. For example, the first data unit is determined by the processing circuit 115 as the first data portion of one page data when detecting that the first data unit is with the specific logical address which is received by the controller 100 for the first time.

For data programming/writing at the second time, when the flash memory controller 100 receives the second data unit (i.e. the second 4 KB data) and the specific logical address from the host device 101, the processing circuit 115 can know/detect that the specific logical address is received for the second time and the second data unit should be considered as the second data portion of one page data. The processing circuit 115 is arranged to issue/send the copy back read command to the flash memory 102 to read or load the page data previously programmed/written into the page of the cell array 102A into the buffer 102B, and then to issue/send the program/write command 80h (carrying the specific physical address) to the flash memory 102 to write the second 4 KB data to update/replace a second portion data of the page data buffered in the buffer 102B wherein the first portion data of such buffered page data means the first 4 KB data. That is, in this situation, the second 4 KB data is used to replace the second portion data (i.e. 4 KB dummy data), and the updated page data buffered in the buffer 102B has the first 4 KB data, the second 4 KB data, and subsequent 24 KB dummy data. The transmission time READ of copy back read command is followed by the read transfer time TR from the cell array 102A to the buffer 102B, and the read transfer time TR is followed by the transmission time of the program/write command 80h which is followed by a transmission time of the second 4 KB data which is followed by the page program time TPROG. The flash memory 102 is arranged to program/write the updated page data into a page of the cell array 102A during the page program time TPROG.

Similarly, for data programming at the third time, when the flash memory controller 100 receives the third data unit (i.e. the third 4 KB data) and the specific logical address from the host device 101, the processing circuit 115 can know/detect that the specific logical address is received for the third time and the third data unit should be considered as the third data portion of one page data. The processing circuit 115 is arranged to issue/send the copy back read command to the flash memory 102 to read or load the page data previously programmed/written into the page of the cell array 102A into the buffer 102B, and then to issue/send the program/write command 80h (carrying the specific physical address) to the flash memory 102 to write the third 4 KB data to update/replace a third portion data of the page data buffered in the buffer 102B wherein the first and second portion data of such buffered page data respectively mean the first 4 KB data and the second 4 KB data. That is, in this situation, the third 4 KB data is used to replace the third portion data (i.e. 4 KB dummy data), and the updated page data buffered in the buffer 102B has the first 4 KB data, the second 4 KB data, the third 4 KB, and subsequent 20 KB dummy data. Similarly, the transmission time READ of copy back read command is followed by the read transfer time TR from the cell array 102A to the buffer 102B, and the read transfer time TR is followed by the transmission time of the program/write command 80h which is followed by a transmission time of the third 4 KB data which is followed by the page program time TPROG. The flash memory 102 is arranged to program/write the updated page data into a page of the cell array 102A during the page program time TPROG.

Similarly, the process of data programming/writing for the fourth 4 KB data, fifth 4 KB data, sixth 4 KB data, seventh 4 KB data, and eighth 4 KB data is similar to the process of data programming the second 4 KB data or the third 4 KB data. The transmission time READ of the copy back read command is followed by the read transfer time TR from the cell array 102A to the buffer 102B, and the read transfer time TR is followed by the transmission time of the program/write command 80h which is followed by a transmission time of 4 KB data which is followed by the page program time TPROG. The flash memory 102 is arranged to program/write the updated page data into a page of the cell array 102A during the page program time TPROG. This can be seen on FIG. 3.

As mentioned above, a conventional flash memory controller needs to transmit and program/write one page data (32 KB) to a flash memory even though the data amount received from a host device does not exceed above the size of one page data. The performance of conventional scheme is limited. Compared to the conventional scheme, the total consumed time of transmission time READ of the copy back read command, the read transfer time TR, and transmission time of 4 KB data is much shorter than the transmission time of one page 32 KB data. Thus, the flash memory controller 100 is capable of reducing the total waiting time for data programming/writing. IOPS performance can be significantly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flash memory controller, comprising:
a first I/O interface, configured to be connected to a bus of a host to receive a data unit from the host;
a second I/O interface, configured to be connected to a flash memory;
a processing circuit, coupled between the first I/O interface and the second I/O interface, configured to control the flash memory to load a full page data from the flash memory into a buffer of the flash memory, and to write the data unit into the buffer via the second I/O interface to update or replace a portion data of the full page data stored in the buffer wherein the full page data updated by the data unit is then written into the flash memory.

2. The flash memory controller of claim 1, wherein the processing circuit is arranged to issue a copy back read command to the flash memory, to control the flash memory load the full page data which is not updated from the flash memory into the buffer, and then to issue a write command to write the data unit to replace/update the portion data of the full page data and to write the full page data unit which has been updated into the flash memory.

3. The flash memory controller of claim 2, wherein the processing circuit is arranged to determine whether the data unit is used for forming a first portion data of the full page data before issue the copy back read command to the flash memory.

4. The flash memory controller of claim 3, wherein the processing circuit is arranged to issue the copy back read command to the flash memory when determining that the data unit is not used for forming the first portion data of the full page data.

5. The flash memory controller of claim 1, wherein the data unit is used for forming a particular portion data of the full page data.

6. The flash memory controller of claim 1, wherein a size of the data unit is smaller than a size of the full page data.

7. A method of a flash memory controller connected to a flash memory, comprising:
receiving a data unit from the host via a bust of the host;
controlling the flash memory to load a full page data from the flash memory into a buffer of the flash memory; and
writing the data unit into the buffer to update or replace a portion data of the full page data stored in the buffer, to control the flash memory write the full page data which has been updated by the data unit from the buffer into the flash memory.

8. The method of claim 7, the controlling step comprises:
issuing a copy back read command to the flash memory, to control the flash memory load the full page data which is not updated from the flash memory into the buffer; and
the writing step comprises:
issuing a write command to the flash memory to write the data unit to replace/update the portion data of the full page data and to write the full page data unit which has been updated into the flash memory.

9. The method of claim 8, further comprising:
determining whether the data unit is used for forming a first portion data of the full page data before issuing the copy back read command to the flash memory.

10. The method of claim 9, wherein the copy back read command is issued to the flash memory when determining that the data unit is not used for forming the first portion data of the full page data.

11. The method of claim 7, wherein the data unit is used for forming a particular portion data of the full page data.

12. The method of claim 7, wherein a size of the data unit is smaller than a size of the full page data.
